(19) United States
(12) Patent Application Publication
(10) Pub. No.: US 2010/0059306 A1
(43) Pub. Date: Mar. 11, 2010

(54) STEERING MECHANISM COMPRISING A PRESSURE RELIEF VALVE FOR DAMPING THE END POSITION AND PROTECTING THE PUMP FROM BEING OVERLOADED

(75) Inventors: Bernd Langkamp, Lichtenwald (DE); Edwin Breuning, Denkendorf (DE)

Correspondence Address: CONNOLLY BOVE LODGE & HUTZ LLP, 1875 EYE STREET, N.W., SUITE 1100, WASHINGTON, DC, 20006, US

(73) Assignee: Thyssen Krupp Presta Steertec GmbH, Dusseldorf (DE)

(21) Appl. No.: 12/091,803

(22) PCT Filed: Aug. 23, 2006
(86) PCT No.: PCT/EP2006/008247

§ 371 Date: Dec. 10, 2008

(30) Foreign Application Priority Data
Oct. 28, 2005 (DE) 10 2005 052 078.2

(51) Int. Cl. B62D 5/083

(52) U.S. Cl. 180/406

(57) ABSTRACT

The invention relates to a steering device for vehicles with a double-acting hydraulic working cylinder, which is divided into two working chambers by a piston, which is displaceably mounted in the working cylinder, to pivot at least one vehicle wheel, and a pressurizing means device producing a volume flow of a hydraulic medium, the hydraulic medium being supplied to a rotary slide valve, which supplies the volume flow, depending on the rotary slide valve position, to the working chambers of the double-acting hydraulic working cylinder or to a reservoir for the hydraulic medium, wherein when a certain pressure is exceeded in the feed line to the rotary slide valve, a pressure relief valve guides at least a part of the total volume flow of the hydraulic medium past the rotary slide valve in particular to the reservoir.

The present invention relates to a steering device according to the features of the preamble of claim 1.

Generic steering devices are sufficiently known. To protect the pump from being overloaded and to damp the end position, these have overflow channels, via which the hydraulic medium can overflow from one working chamber to the other working chamber shortly before reaching an end position and the servo pressure is thus relieved. The overflow channels can, as known from DE 42 21 459 or DE 938527, be formed by grooves which are incorporated in the inner wall of the working cylinder and arranged in the region of the end positions. If the piston is in an end position, the hydraulic medium can arrive from one working chamber via the grooves past the piston into the other working chamber.

It is furthermore known to directly arrange overflow channels on the double-acting working cylinder. These overflow channels are, in this case, either incorporated directly by means of bores in the housing of the working cylinder or arranged via additional channels on the outside of the working cylinder. Valves, such as, for example, a pressure relief valve may also be arranged in the overflow channel, as known from DE-OS 1 755 048.

The disadvantage In the above-described steering devices is that the overflow channels, to relieve the servo pressure on reaching the end position, are arranged directly on or in the working cylinder and only lead to a flow around the piston, so, disadvantageously, flow noises are linked and, in addition, the structure of the working cylinder is technically more complex and its housing dimensions are enlarged. Furthermore, no servo assistance is present when moving out of the end position, i.e. in this region, steering can only be mechanical.

The object of the present invention is therefore to develop an existing steering device such that a relief of the servo pressure takes place shortly before or on reaching the end position, wherein damping of the end position and protection of the pump from being overloaded is achieved by additional cooling of the hydraulic medium.

This object is achieved according to the invention with a steering device with the features of claim 1. Advantageous configurations emerge through the features of the sub-claims.

Damping of an end position and an additional cooling power can be achieved in a standard steering via the feed or return hose by means of the use of an excess pressure valve separately arranged parallel to the standard steering or its rotary slide valve and working cylinder, without technical changes having to be made to the double-acting working cylinder.

By the advantageous use of the pressure relief valve in a speed-dependent steering, advantageous damping of the end position can also be achieved in the parking region by increasing the hand torque as well as an additional cooling of the hydraulic medium by circulating the fluid via the hoses and the parameter branch.

A possible embodiment for a standard steering and for a speed-dependent steering will be described below in each case with the aid of drawings, in which:

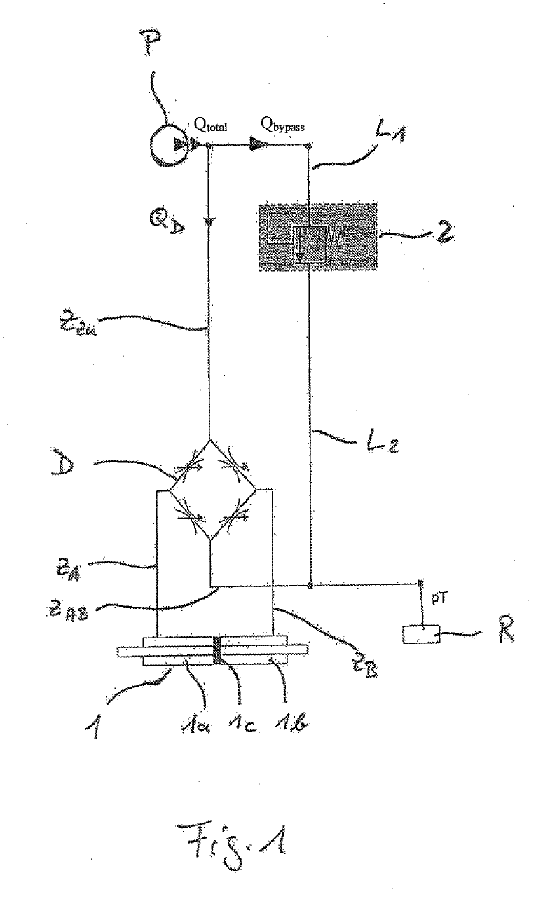

FIG. 1 shows a standard steering with a pressure relief valve connected in parallel;

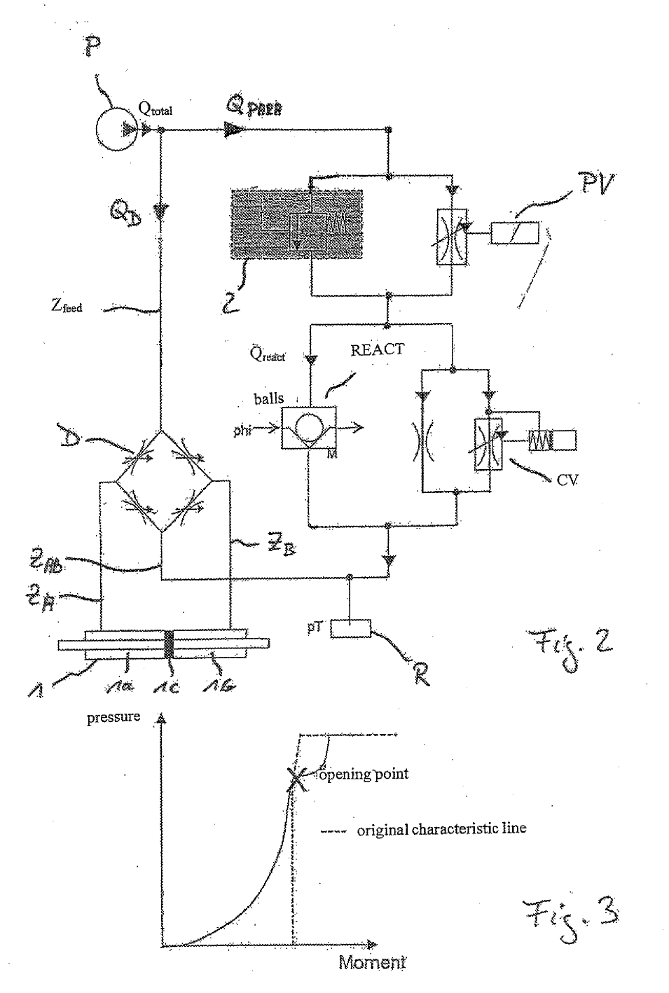

FIG. 2 shows a speed-dependent steering device with an additional pressure relief valve according to the invention;

FIG. 3 shows a pressure-torque characteristic line diagram.

FIG. 1 shows a standard steering device with hydraulic assistance. The steering device has a double-acting cylinder piston unit 1, the cylinder of which is divided into the two working chambers 1a and 1b by the piston 1c. The hydraulic medium arrives via feed lines Z_{A} and Z_{B} from the rotary slide valve D into the two working chambers 1a and 1b and displaces the piston 1c to the left or right. The rotary slide valve D is connected to the pressurising means source P via the feed line Z_{feed} and is connected via the return flow line Z_{AB} to the reservoir R for the hydraulic medium. The pressurising means source P, usually a hydraulic pump, conveys the volume flow Qₜₒₜₐₗ, which, if the pressure relief valve 2 is closed, arrives complete at the rotary slide valve D and from there at one of the two working chambers 1a, 1b or the reservoir R. As soon as a pressure builds up in the feed line Z_{feed} as a result of steering into an end position, i.e. on reaching the maximum steering angle, said pressure being greater than the pressure adjusted in the pressure relief valve 2, for example by means of a spring, the pressure relief valve 2 opens and a partial volume flow Q_{bypass} of the total volume flow Qₜₒₜₐₗ flows past the rotary slide valve D to the reservoir R. As a result, the pressure in the feed line Z_{feed} and the respective working chamber 1a or 1b in the piston-cylinder unit 1 is regulated and the hydraulic medium is cooled simultaneously via the connecting lines L₁ and L₂. The pressure relief valve 2 may either be arranged close to the pressurising means source P or the rotary slide valve D. It is also possible to integrate the pressure relief valve 2 directly in the steering housing. For this purpose, corresponding channels are to be arranged in the steering housing as well as, for example, a spring-loaded ball as the valve actuator.

FIG. 2 shows an embodiment of a speed-dependent steering device in which the pressure relief valve 2 is connected in parallel to a speed-controlled proportional valve PV. The proportional valve PV is generally closed at low speeds, such as occur, for example, during perking. In this case, a hand torque increase is no longer possible on reaching an end position by means of the reaction device REACT without the pressure relief valve 2 connected in parallel, as no volume flow can arrive at the reaction device through the closed proportional valve PV. In this speed-dependent steering device corresponding to the prior art, the hand torque, as shown by the dashed line in the diagram of FIG. 3 only increases linearly.

The reaction device REACT generally has balls which are pressed onto oblique faces by means of the volume flow Q_{react}, so a reaction force is produced to increase the hand torque. A pressure-controlled control valve CV is connected in parallel to the reaction device to limit the hand torque produced by the reaction device. At low vehicle speeds the pressure in the feed line Z_{feed} increases up to a maximum pressure, after which the pressure relief valve 2 then opens and a volume flow Q_{PARA} flows through the pressure relief valve 2. This volume flow divides and flows partly through the reaction device REACT and, from a certain pressure, through the control valve CV. The volume flow Q_{react} in this case produces, as shown in the diagram of FIG. 3 by the solid line, an increase in the hand torque with pressure not noticeably further increasing in the feed line Z_{feed} or the working chamber of the piston-cylinder unit 1.

If the vehicle exceeds a minimum speed, the end position (maximum steering angle is usually not reached and therefore neither is the maximum pressure at which the pressure relief valve 2 opens. As a result, the speed-dependent control of the proportional valve PV is not disturbed by the pressure relief valve 2, so the entire volume flow Q_{PARA} flows through the proportional valve PV.

The pressure relief valve 2 additionally integrated in the steering devices present therefore generally does not influence the steering device, so it can also be integrated without problems in existing steering systems.

Captions

FIG. 1

Q_{ges}=Qₜₒₜₐₗ

Q_{Bypass}=Q_{bypass}

FIG. 2

Q_{ges}=Qₜₒₜₐₗ

Q_{Rü}=Q_{react}

RÜ=REACT

Kugeln=balls

Druck=pressure

Öffnungspunkt=opening point

ursprüngliche Kennlinie=original characteristic line

Z_{zu}=Z_{feed}

RS=CV

1. Steering device for vehicles with a double-acting hydraulic working cylinder, which is divided into two working chambers by a piston, which is displaceably mounted in the working cylinder, to pivot at least one vehicle wheel, and a pressurizing means device producing a volume flow (Qₜₒₜₐₗ) if a hydraulic medium, the hydraulic medium being supplied to a rotary slide valve, which supplies the volume flow, depending on the rotary slide valve position, to the working chambers of the double-acting hydraulic working cylinder or to a reservoir for the hydraulic medium, wherein when a certain pressure is exceeded in the feed line to the rotary slide valve, a pressure relief valve guides at least a part of the total volume flow of the hydraulic medium past the rotary slide valve in particular to the reservoir.

2. The steering device according to claim 1, wherein the pressure relief valve is connected in parallel to a proportional valve of a speed-dependent steering device.

3. The steering device according to claim 2, wherein the proportional valve is closed in the parking region of the speed-dependent steering device and the partial volume flow of the hydraulic medium, which is branched off via the pressure relief valve, arrives at least partly via a connecting line at a reaction device to produce an additional hand torque, before the branched-off volume flow arrives in the reservoir.

4. The steering device according to claim 3, wherein a pressure-controlled control gate valve is connected in parallel to the reaction device.

5. The steering device according to claim 1, wherein the pressure relief valve opens from a certain pressure, in particular from a pressure of 120 bar.

6. The steering device according to claim 1, wherein the pressure relief valve opens at a pressure which adjusts in the feed line, which adjusts at the end stop of the steered vehicle wheels in the feed line to the rotary slide valve.
